(19) United States
(12) Patent Application Publication
(10) Pub. No.: US 2025/0389804 A1
(43) Pub. Date: Dec. 25, 2025

(54) IMAGING OPTICAL SYSTEM

(71) Applicant: Wilfried LUTZ, Innsbruck (AT)

(72) Inventor: Wilfried LUTZ, Innsbruck (AT)

(21) Appl. No.: 19/307,487

(22) Filed: Aug. 22, 2025

Related U.S. Application Data
(63) Continuation of application No. PCT/AT2024/060064, filed on Feb. 21, 2024.

(30) Foreign Application Priority Data
Feb. 23, 2023 (AT) A 50124/2023

(51) Int. Cl. G01S 3/782; G01B 11/26; G01S 5/16; G02B 5/10

(52) U.S. Cl. CPC G01S 3/782; G01B 11/26; G01S 5/16; G02B 5/10

(57) ABSTRACT

An imaging optical system for imaging at least one light source onto a light-sensitive sensor, includes an optical aperture, a beam-forming optical element, and the light-sensitive sensor. The beam-forming optical element is a planoconcave cylindrical mirror, more particularly a planoconcave circular-cylindrical mirror.

The present application is a continuation of International Application PCT/AT2024/060064 filed on Feb. 21, 2024. Thus, all of the subject matter of International Application PCT/AT2024/060064 is incorporated herein by reference.

### BACKGROUND OF THE INVENTION

The present invention relates to an imaging optical system for imaging at least one light source onto at least one light-sensitive sensor, the use of such an imaging optical system for detecting the position and/or movement of at least one object in space, and a method for detecting the position and/or movement of at least one object in space.

In the prior art, WO 2004/046770 A1 discloses a device for imaging light sources through at least one optical lens onto at least one light-sensitive sensor, wherein the optical system used to generate the image comprises a beam-forming optical element in the form of at least one lens with a toroidal and an aspherical form. By using a lens with a toroidal and an aspherical form, the spherical aberration that commonly occurs in optical lenses, also called aperture error or spherical aberration, can be minimized. By using lenses with a toroidal and an aspherical form, improved image quality can be achieved, in particular when the light is incident over a wide angular range.

However, the production of lenses with a toroidal and an aspherical form is technically complex and involves high production costs.

### SUMMARY OF THE INVENTION

The object of the invention is to achieve a precise optical imaging of at least one light source onto at least one light-sensitive sensor using an imaging optical system that is easy to manufacture, with which the precise detection of the position and/or movement of at least one object in space is also possible.

The imaging optical system is fundamentally suitable for imaging at least one light source, which can emit, for example, monochromatic and/or polychromatic light in the visible and/or outside the visible range, in particular infrared, onto at least one correspondingly light-sensitive sensor.

An object, the position and/or movement of which in space is to be detected can emit light itself and thus form a light source. An object can also have a light source that can be arranged on the object. It is also conceivable that light reflected from an object is detected by the imaging optical system. For this purpose, for example, a suitable reflector can be arranged on an object.

The light-sensitive sensor can basically be provided in the form of a photoelectric sensor, which converts light incident on the light-sensitive sensor into an electrical signal.

The imaging optical system comprises at least one optical aperture, at least one beam-forming optical element and at least one light-sensitive sensor.

In the context of geometric optical system, an optical aperture can be used to mechanically limit a beam of rays during optical imaging.

A beam-forming optical element can generally be used to form a light beam, in particular by changing the propagation direction of the light transmitted and/or reflected by the optical element.

In an advantageous embodiment, the at least one beam-forming optical element is provided in the form of a planoconcave cylindrical mirror.

A concave mirror can generally be understood as a planoconcave cylindrical mirror. Specifically, this can be understood as a mirror that is concave in one direction, i.e. curved inwards. A planoconcave cylindrical mirror can be flat along one axis and have a curvature along an axis substantially orthogonal thereto. The curvature, and thus the lateral surface of the cylindrical mirror, can generally be elliptical, parabolic, acylindrical, in particular aspherically cylindrical, or in particular circular with constant curvature.

Along the lateral surface, the planoconcave cylindrical mirror can have a concave curved course in the circumferential direction. In a height direction, i.e. seen parallel to the cylinder axis, the planoconcave cylindrical mirror can have a flat course.

In beam-forming optical elements such as optical lenses, in which the formation of a light beam occurs by transmission, imaging errors occur due to different beam paths and optical path lengths caused by the thickness and form of the lenses used in practice. Additional imaging errors can occur due to wavelength-dependent refractive indices. Additional optical elements may be necessary for beam guidance.

With a beam-forming optical element in the form of an easy-to-manufacture planoconcave cylindrical mirror, a light beam can be formed essentially solely by reflection.

A planoconcave cylindrical mirror can simultaneously serve to guide the beam, i.e. to form the beam path, and to focus the beam.

The beam path of the imaging optical system can generally run in an optically transparent medium. The medium can be, for example, vacuum, generally gaseous, in particular air, glass or an optically transparent plastic.

The beam path of the imaging optical system can essentially be understood as the path followed by the incident light from the optical aperture to the light-sensitive sensor.

Particularly in an embodiment with glass as the optical medium, a high temperature stability of the structure between the aperture, optical element and sensor can be achieved.

In an embodiment with glass or an optically transparent plastic as the optical medium, a planoconcave cylindrical mirror of the imaging optical system can be formed by a suitable mirror coating of a correspondingly planoconcave cylindrical outer surface of a body of the optical medium.

Advantageously, the at least one beam-forming optical element can be arranged in the optical beam path between the at least one optical aperture and the at least one light-sensitive sensor. This allows the optical aperture to mechanically limit the light flux incident on the planoconcave cylindrical mirror.

The at least one optical aperture and/or the at least one light-sensitive sensor can be arranged outside an optical plane of the at least one beam-forming optical element. The optical plane of the planoconcave cylindrical mirror can be understood as a plane of symmetry passing through the center of curvature of the cylindrical mirror, analogous to an optical axis. Light rays incident on the planoconcave cylindrical mirror in the optical plane are reflected in the optical plane. Light rays incident on the planoconcave cylindrical mirror outside the optical plane are subject to reflection—and thus to beam path forming—and beam focusing.

The imaging optical system can have a folded beam path between the at least one optical aperture and the at least one light-sensitive sensor. The beam path can deviate from a straight line, which means that the imaging optical system can require less space. In contrast to an imaging optical system with transmission-based optical lenses, a planoconcave cylindrical mirror can reflect incident light rays to form an image of an optical aperture onto a light-sensitive sensor in a folded beam path that deviates from a straight line.

The imaging optical system can generally image a slit opening of the at least one optical aperture onto the at least one light-sensitive sensor.

In an advantageous embodiment, the at least one light-sensitive sensor can be an area sensor or a line sensor. An area sensor or a line sensor can be constructed from a large number of individual sensors, also called pixels, arranged in a flat or linear manner. Light incident on it can be detected by one or more individual sensors according to an intensity distribution of the incident light. Depending on the individual sensors illuminated by the incident light, a position of the impact point along the area sensor or line sensor can be determined. An embodiment with an analog light-sensitive sensor, which has a substantially isotropic sensor surface and can provide continuous position information on the incident light, is also conceivable.

A longitudinal extension of the optical sensor can correspond to a dimension of a light-sensitive region of the sensor, for example the dimension of a row of pixels or a sensor area.

The at least one optical aperture may be a slit aperture having a slit opening with a predetermined or predeterminable width along a transverse direction and a predetermined or predeterminable height along a longitudinal direction. A slit aperture can generally be characterized by its width. If a length of the slit is also specified or can be specified, this can be characterized by specifying a height.

A position and/or a movement of at least one object in space can be characterized by at least one angle relative to an optical aperture of the imaging optical system. An angle, for example a polar angle and/or an azimuth angle, relative to an optical aperture of the imaging optical system can be measured or defined relative to a direction of the width and/or a direction of the height of the optical aperture.

For example, an angle can be measured relative to a normal to a plane of an optical aperture. If the orientation of an aperture relative to a given or predeterminable spatial direction, for example relative to a horizontal or a vertical, is known, the position of an object in space can be characterized, for example by trigonometric relationships.

Advantageously, the slit opening of the optical aperture runs parallel to a cylinder axis of the beam-forming optical element when viewed along the height. In one embodiment of the beam-forming optical element as a planoconcave circular cylindrical mirror, the cylinder axis runs through the center of curvature of the mirror. An optical aperture provided in the form of a slit aperture can be aligned with a height of the optical aperture, i.e. seen in the longitudinal direction of the slit, relative to the mirror in such a way that the cylinder axis runs parallel to the direction of the height of the slit.

In such an arrangement, light incident on the optical aperture at different azimuth angles, i.e. at different angles to a longitudinal direction of the slit, strikes different regions along a height direction of the planoconcave cylindrical mirror at different angles and is reflected according to the planar course in this direction.

The at least one light-sensitive sensor can be provided in the form of a line sensor or an area sensor with a longitudinal extension along a longitudinal direction, wherein the longitudinal direction advantageously runs transversely, in particular at right angles to a cylinder axis of the beam-forming optical element when viewed in projection onto the beam path between the mirror and the sensor.

In such an arrangement, light incident on the optical aperture at different polar angles, i.e. at different angles around a longitudinal direction of the slit aperture, strikes different regions along a circumferential direction of the planoconcave cylindrical mirror on this at different angles and is reflected according to the concave course in this direction.

The at least one light-sensitive sensor can be provided in the form of a line sensor or as an area sensor with a longitudinal extension along a longitudinal direction, wherein a polar angle about a longitudinal direction of the optical aperture can be determined from a position of the imaged light source along the longitudinal extension of the at least one light-sensitive sensor.

The imaging optical system can comprise an evaluation device by means of which a polar angle about a longitudinal direction of the optical aperture can be determined from the position of impact along the longitudinal extent of the at least one light-sensitive sensor.

The evaluation device can have at least one computing unit which is in a data connection with at least one memory unit of the evaluation device or can be brought into such a connection. Data on distances, dimensions, geometries and focal lengths of the imaging optical system can be stored in the memory unit of the evaluation device. An embodiment of the evaluation device with sensors for detecting the orientation of the imaging optical system relative to a predeterminable or predetermined spatial direction is also conceivable.

A computer program product may comprise instructions which, when executed by the computing unit, cause it to execute a method for detecting the position and/or movement of at least one object in space from the memory unit.

The computer program product can, for example, be stored in at least one memory unit of the evaluation device and executed by the at least one computing unit of the evaluation device.

By arranging two or more imaging optical systems, or one imaging optical system with a corresponding number of apertures, mirrors and sensors oriented in different spatial directions, the positions of light sources, and if necessary their movement, in space can be determined by determining the respective angles and, if necessary, their change. In addition, the distance between objects and the imaging optical system can be determined stereoscopically.

By focusing light onto a light-sensitive sensor, more sensitive detection and higher spatial resolution can generally be achieved, especially with multiple adjacent light sources.

The at least one light-sensitive sensor can be arranged substantially at a distance from the at least one beam-forming optical element that is smaller than the radius of curvature, preferably smaller than three-quarters of the radius of curvature, particularly preferably smaller than two-thirds of the radius of curvature, in particular substantially half of the radius of curvature, of the at least one beam-forming optical element. This allows a reduced imaging of the optical aperture on the light-sensitive sensor, which enables more sensitive detection and higher spatial resolution.

The at least one light-sensitive sensor can be arranged substantially at a distance from the at least one beam-forming optical element that is greater than a quarter of the radius of curvature, preferably greater than a third of the radius of curvature, particularly preferably substantially half of the radius of curvature, of the at least one beam-forming optical element. This allows a reduced imaging of the optical aperture on the light-sensitive sensor, which enables more sensitive detection and higher spatial resolution.

The at least one aperture can be arranged substantially at a distance from the at least one beam-forming optical element that is smaller than the radius of curvature, preferably smaller than three-quarters of the radius of curvature, particularly preferably smaller than two-thirds of the radius of curvature, in particular substantially half of the radius of curvature, of the at least one beam-forming optical element. This can be used to influence the angular range from which light from a light source can hit the beam-forming optical element.

The at least one aperture can be arranged substantially at a distance from the at least one beam-forming optical element that is greater than a quarter of the radius of curvature, preferably greater than a third of the radius of curvature, particularly preferably substantially half of the radius of curvature, of the at least one beam-forming optical element. This can be used to influence the angular range from which light from a light source can hit the beam-forming optical element.

The distance between the at least one light-sensitive sensor and the at least one beam-forming optical element and the distance between the at least one optical aperture and the at least one beam-forming optical element can be adapted to one another. For a given dimension, geometry and focal length of the beam-forming optical element, a given aperture and a given longitudinal extent of the sensor, the distance between the at least one optical aperture and the at least one beam-forming optical element can specify the angular range from which light emitted by a light source can hit the mirror and be reflected by it. The longitudinal extension of the sensor, i.e. the sensor length, can determine the angular range over which light reflected by the mirror can be detected by the sensor.

The at least one optical aperture, the at least one beam-forming optical element and the at least one light-sensitive sensor can be arranged at vertices of a triangle. This results in an arrangement of the imaging optical system that deviates from a straight line. The parts of the imaging optical system, which are arranged partially next to each other, can require less space.

The at least one optical aperture and the at least one light-sensitive sensor can be arranged spatially between the at least one light source and the at least one beam-forming optical element. This means that the parts of the imaging optical system can be arranged partially next to each other.

An imaging optical system as described above can be part of an arrangement comprising at least one imaging optical system and at least one light source. The at least one light source can be arranged on at least one object the position and/or movement in space of which is to be detected.

Protection is also sought for the use of an imaging optical system as described above for detecting the position and/or movement of at least one object in space, wherein at least one light source is arranged on the at least one object.

Protection is also sought for a method for detecting the position and/or movement of at least one object in space. In particular, an imaging optical system as described above can be used to carry out the method.

Light emitted by at least one object can initially pass through at least one optical aperture. Subsequently, the light can impinge on at least one beam-forming optical element in the form of a planoconcave cylindrical mirror and be reflected and, if necessary, focused, wherein beam guidance and beam focusing can take place. The light can then hit at least one light-sensitive sensor and be detected by it.

An object the position and/or movement of which in space is to be detected can emit light itself and thus form a light source. An object can also have a light source that can be arranged on the object. It is also conceivable that light reflected from an object is detected by the imaging optical system. For this purpose, for example, a suitable reflector can be arranged on an object.

The light emitted by at least one object can pass through the at least one optical aperture at a polar angle around a longitudinal direction of the optical aperture, wherein the light can then hit a cylinder lateral segment of the planoconcave cylindrical mirror and be reflected depending on the polar angle. Depending on the polar angle, the light can be incident and detected at a position along a longitudinal extension along a longitudinal direction of at least one light-sensitive sensor in the form of a line sensor or area sensor. The polar angle can be determined by an evaluation device of an imaging optical system from the position of the impact along the longitudinal extension along a longitudinal direction of the at least one light-sensitive sensor.

The emission of light from multiple objects or light sources to be detected can be clocked serially to enable differentiation between the different objects and light sources. Different spectral distributions and sensors with different sensitivity are also conceivable.

### BRIEF DESCRIPTION OF THE DRAWINGS

Exemplary embodiments of the invention will be discussed below with reference to the drawings, in which:

FIG. 1 is a perspective view of an embodiment of an imaging optical system and an object with a light source arranged thereon at a first position in space,

FIG. 2 is a perspective view of an imaging optical system and an object with a light source arranged thereon at a second position in space,

FIG. 3 is a perspective view of an imaging optical system with an evaluation device and two objects with a light source arranged thereon at different positions in space,

FIG. 4 is a side view of an imaging optical system and two objects with a light source arranged thereon at different positions in space according to FIG. 3,

FIG. 5 is a plan view of an imaging optical system,

FIG. 6 is a perspective view of an arrangement of three differently mutually oriented imaging optical systems and the detected polar angles of an object in space, and

FIG. 7 is a perspective view of an arrangement of three differently mutually oriented imaging optical systems for detecting a position of an object in space.

### DETAILED DESCRIPTION OF THE INVENTION

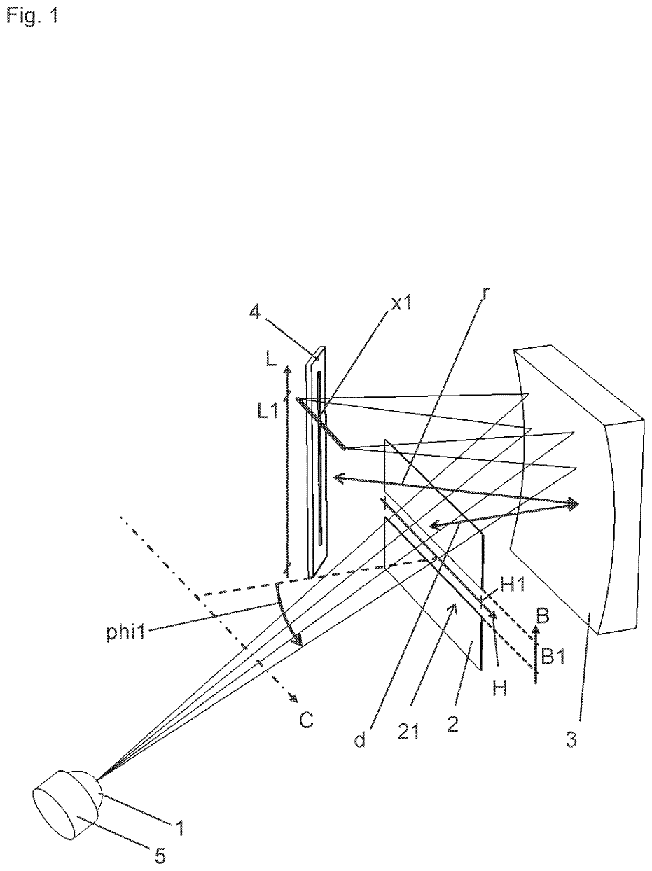

FIG. 1 shows an imaging optical system for imaging a light source 1 arranged on an object 5 onto a light-sensitive sensor 4, wherein the imaging optical system has an optical aperture 2, a beam-forming optical element 3 in the form of a planoconcave cylindrical mirror and a light-sensitive sensor 4. As shown, the imaging optical system images a slit opening 21 of the at least one optical aperture 2 onto the at least one light-sensitive sensor 4.

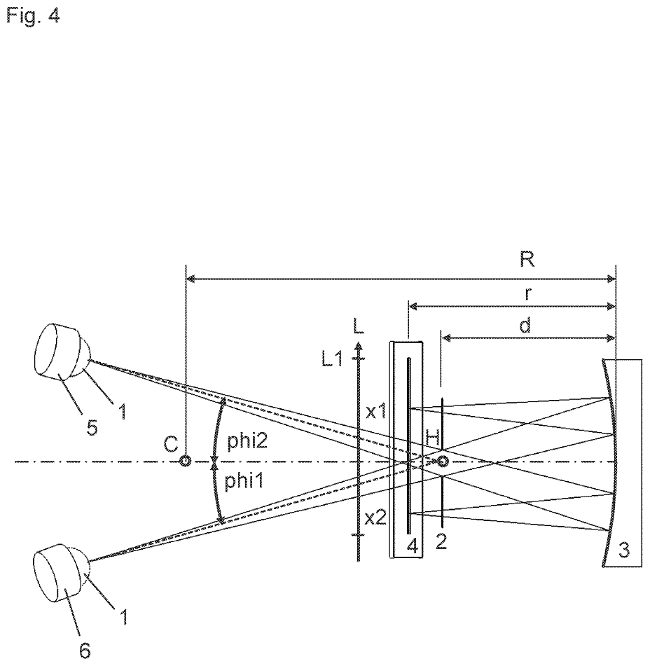

The at least one beam-forming optical element 3 is arranged in the optical beam path between the optical aperture 2 and the at least one light-sensitive sensor 4. The optical aperture 2 and the at least one light-sensitive sensor 4 are arranged outside an optical plane of the at least one beam-forming optical element 3 (see also FIG. 4).

Due to the reflection at the beam-forming optical element 3 in the form of the planoconcave cylindrical mirror, the imaging optical system has a folded beam path between the at least one optical aperture 2 and the at least one light-sensitive sensor 4. The optical aperture 2, the beam-forming optical element 3 and the light-sensitive sensor 4 are arranged at vertices of a triangle, wherein the optical aperture 2 and the at least one light-sensitive sensor 4 are arranged spatially between the at least one light source 1 and the at least one beam-forming optical element 3.

In the embodiment shown, the light-sensitive sensor 4 is provided in the form of a line sensor with a longitudinal extension L1 along a longitudinal direction L. The longitudinal direction L runs transversely, in particular at right angles when viewed in projection along the optical beam path, to a cylinder axis C of the beam-forming optical element 3. The slit opening 21 runs along the longitudinal direction H parallel to a cylinder axis C of the beam-forming optical element 3.

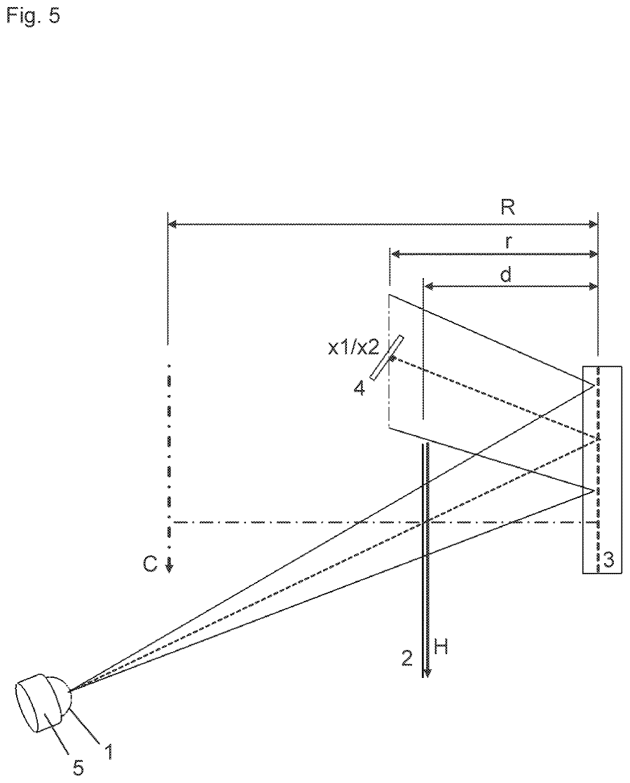

The at least one light-sensitive sensor 4 is arranged substantially at a distance r from the at least one beam-forming optical element 3, which is smaller than the radius of curvature R of the at least one beam-forming optical element 3, wherein the radius of curvature R corresponds to the radial distance of the beam-forming optical element 3 from the cylinder axis C (see FIGS. 4 and 5). In the illustrated embodiment, the distance r corresponds essentially to half the radius of curvature R.

The at least one optical aperture 2 is arranged substantially at a distance d from the at least one beam-forming optical element 3, which is smaller than the radius of curvature R of the at least one beam-forming optical element 3, wherein the radius of curvature R corresponds to the radial distance of the beam-forming optical element 3 from the cylinder axis C (see FIGS. 4 and 5). In the illustrated embodiment, the distance d corresponds essentially to half the radius of curvature R.

In the position of the object 5 with a light source 1 arranged thereon shown in FIG. 1, light rays emanating from the object 5 pass through the aperture 21 at a polar angle phi1 about the longitudinal direction H of the optical aperture 2, here for example measured relative to a normal to the plane of the optical aperture 2. The emitted light hits the sensor 4 along the longitudinal extension L1 at the position x1 on the same.

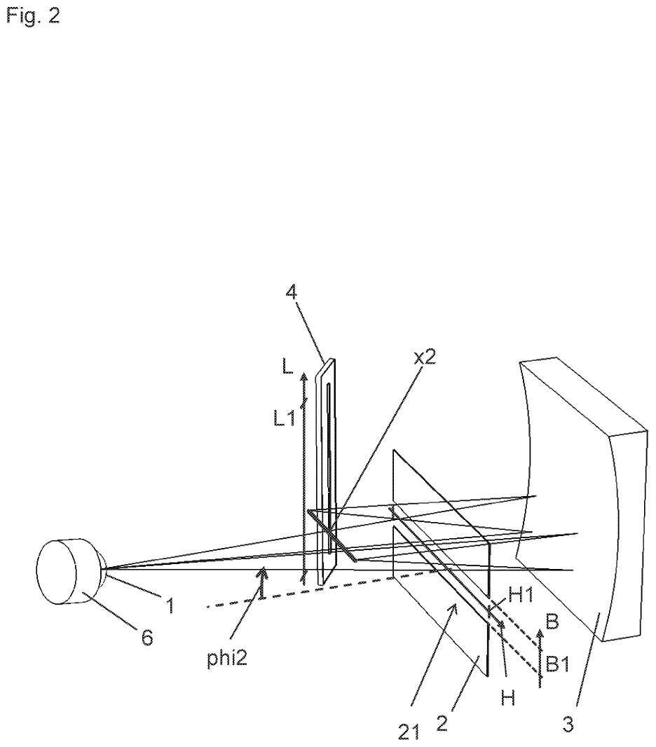

FIG. 2 shows a representation analogous to FIG. 1, wherein the light rays emanating from the object 6 with a light source 1 arranged thereon pass through the aperture 21 at a polar angle phi2 around the longitudinal direction H of the optical aperture 2, again measured relative to a normal to the plane of the optical aperture 2. The emitted light hits the sensor 4 along the longitudinal extension L1 at the position x2 on the same.

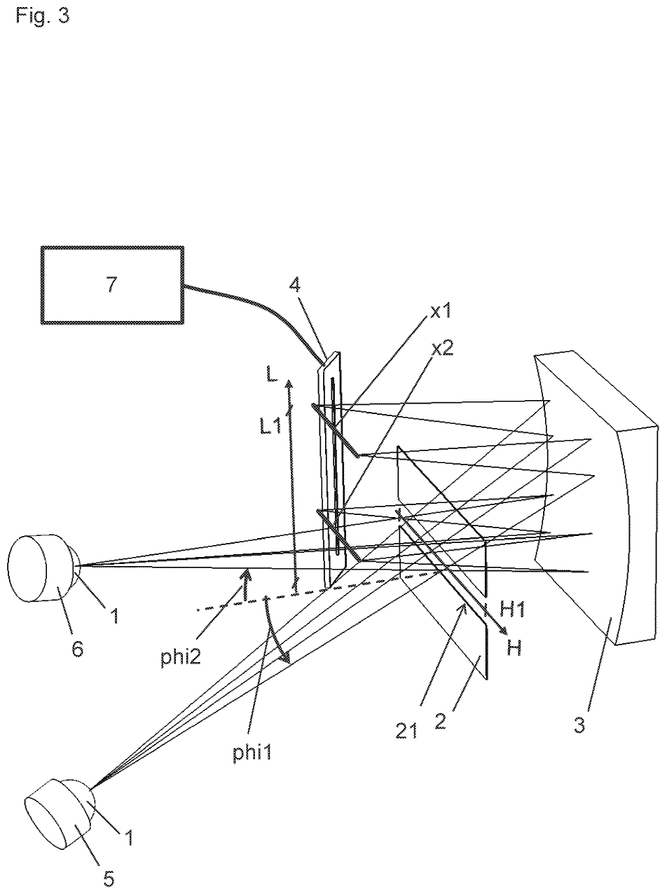

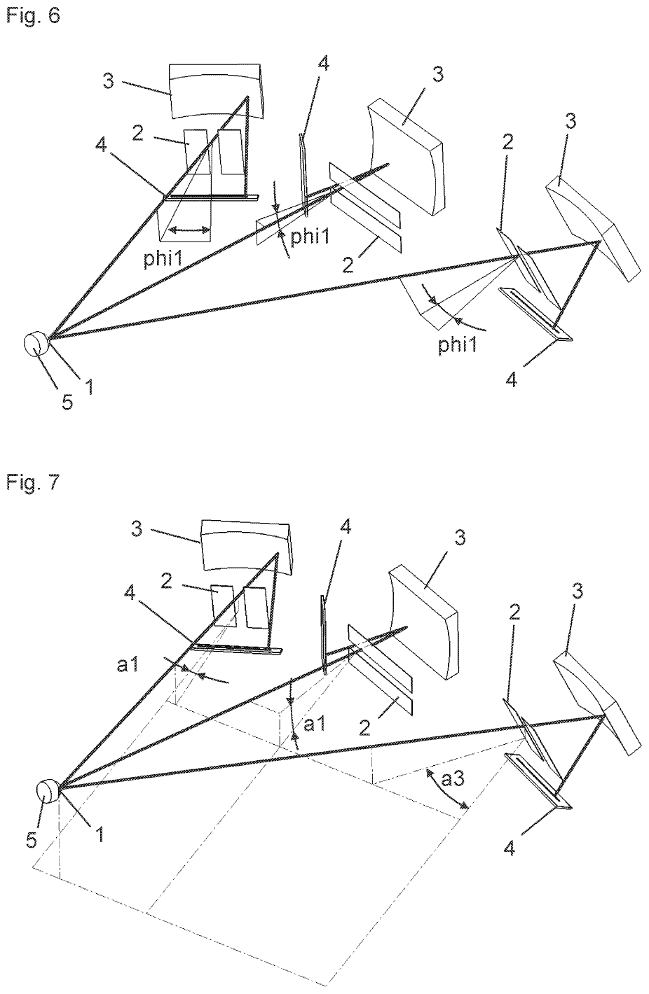

FIG. 3 shows a representation analogous to FIGS. 1 and 2, wherein the imaging optical system is used to characterize the position of the objects 5, 6 in space. In the embodiment shown, a polar angle can be determined around the longitudinal direction H of the optical aperture 2 relative to a normal to the plane of the optical aperture 2. By arranging two or more imaging optical systems, or one imaging optical system with a corresponding number of apertures 2, mirrors 3 and sensors 4 oriented in different spatial directions, as shown in FIGS. 6 and 7, the positions of objects 5, 6 and light sources 1, and possibly their movement, in space can be characterized by determining the respective angles relative to different spatial directions and, if necessary, their changes. In addition, the distance between objects 5, 6 and light sources 1 and the imaging optical system can be determined stereoscopically.

FIG. 4 shows a side view of an imaging optical system and two objects 5, 6 with light sources 1 arranged thereon at different positions in space, wherein the arrangement of the imaging optical system and the objects 5, 6 corresponds to that of FIG. 3. The distances R, r, d and angles phi1, phi2 are shown in projection. A polar angle phi1, phi2 with respect to a normal to the plane of the optical aperture 2 of the light rays emanating from the objects 5, 6 with the light sources 1 can be determined from the positions x1, x2 of the incidence along the longitudinal extension L1 of the at least one light-sensitive sensor 4.

FIG. 5 shows a plan view of an imaging optical system, wherein the arrangement of the imaging optical system and the objects 5, 6 can correspond to FIG. 3. The distances R, r, d and the angles phi1, phi2 are shown in projection.

In order to detect the position and/or movement of at least one object 5, 6 in space, light emitted by at least one object 5, 6 can pass through at least one optical aperture 2, be reflected by at least one beam-forming optical element 3 in the form of a planoconcave cylindrical mirror and impinge on at least one light-sensitive sensor 4 and be detected by the latter.

The emission of light from multiple objects 5, 6 or light sources 1 can be clocked serially to enable differentiation between the objects 5, 6 and light sources 1. Different spectral distributions and sensors with different sensitivity are also conceivable.

The light emitted by at least one object 5, 6 can, as shown in the figures, pass through the at least one optical aperture 2 at different polar angles phi1, phi2 about a longitudinal direction H of the optical aperture 2, impinge on a cylinder lateral segment of the planoconcave cylindrical mirror and be reflected as a function of the polar angle phi1, phi2, impinge and be detected at a position x1, x2 along a longitudinal extension L1 of at least one light-sensitive sensor 4 provided in the form of a line sensor or area sensor as a function of the polar angle phi1, phi2, and as a result the respective polar angle phi1, phi2 can be determined from the position x1, x2 of incidence along the longitudinal extension L1 of the at least one light-sensitive sensor 4 by an evaluation device 7.

FIG. 6 shows a perspective view of an arrangement of three differently mutually oriented imaging optical systems and the polar angles phi1 of an object 5 with a light source 1 arranged thereon in space, each of which is detected by the imaging optical systems. The respectively detected polar angles phi1 are measured here analogously to the previously discussed figures relative to a normal to the plane of the respective optical aperture 2.

With known—or correspondingly detected—dimensions and the spatial orientation of the arrangement of the imaging optical systems, the position of an object 5 in space can be determined trigonometrically from the respectively detected polar angles phi1 through angles a1, a2, a3 relative to predetermined or predeterminable spatial directions. A determination can be made by an evaluation device 7 as shown by way of example in FIG. 3.

FIG. 7 shows a perspective view of an arrangement of three differently mutually oriented imaging optical systems for detecting the position of an object 5 in space. The position of object 5 in space can be characterized by the detected angles a1, a2, a3.

### LIST OF REFERENCE NUMERALS

1 light source
2 optical aperture
3 beam-forming optical element
4 light-sensitive sensor
5 object
6 object
7 evaluation device
21 slit opening
H1 height of slit opening
H longitudinal direction
B1 width of slit opening
B transverse direction
phi1 polar angle
phi2 polar angle
C Cylinder axis
R radius of curvature
L longitudinal direction
L1 longitudinal extension
x1 position
x2 position
r distance
d distance

1. An imaging optical system for imaging at least one light source onto at least one light-sensitive sensor, comprising:
at least one optical aperture,
at least one beam-forming optical element, and
the at least one light-sensitive sensor,
wherein the at least one beam-forming optical element is a planoconcave cylindrical mirror, in particular a planoconcave circular-cylindrical mirror.

2. The imaging optical system according to claim 1, wherein the at least one beam-forming optical element is arranged in the optical beam path between the at least one optical aperture and the at least one light-sensitive sensor.

3. The imaging optical system according to claim 1, wherein the at least one optical aperture and/or the at least one light-sensitive sensor is or are arranged at least partially outside an optical plane of the at least one beam-forming optical element.

4. The imaging optical system according to claim 1, wherein the imaging optical system has a folded beam path between the at least one optical aperture and the at least one light-sensitive sensor.

5. The imaging optical system according to claim 1, wherein the imaging optical system images a slit opening of the at least one optical aperture onto the at least one light-sensitive sensor.

6. The imaging optical system according to claim 1, wherein the at least one light-sensitive sensor is an area sensor or a line sensor.

7. The imaging optical system according to claim 1, wherein the at least one optical aperture is a slit aperture with a slit opening with a predetermined or predeterminable width along a transverse direction and a predetermined or predeterminable height along a longitudinal direction.

8. The imaging optical system according to claim 7, wherein the slit opening extends along the longitudinal direction parallel to a cylinder axis of the beam-forming optical element.

9. The imaging optical system according to claim 1, wherein the at least one light-sensitive sensor is a line sensor or an area sensor with a longitudinal extension along a longitudinal direction of the sensor and the longitudinal direction extends transversely, in particular at right angles, to a cylinder axis of the beam-forming optical element.

10. The imaging optical system according to claim 1, wherein the at least one light-sensitive sensor is provided in the form of a line sensor or an area sensor with a longitudinal extension along a longitudinal direction of the sensor and a polar angle about a longitudinal direction of the optical aperture can be determined from a position of the imaged light source along the longitudinal extension of the at least one light-sensitive sensor.

11. The imaging optical system according to claim 1, wherein:
the at least one light-sensitive sensor is arranged substantially at a distance from the at least one beam-forming optical element which is smaller than the radius of curvature, preferably smaller than three quarters of the radius of curvature, particularly preferably smaller than two-thirds of the radius of curvature, in particular substantially equal to half the radius of curvature, of the at least one beam-shaping optical element, and/or
the at least one optical aperture is arranged substantially at a distance from the at least one beam-forming optical element which is smaller than the radius of curvature, preferably smaller than three quarters of the radius of curvature, particularly preferably smaller than two-thirds of the radius of curvature, in particular substantially half of the radius of curvature, of the at least one beam-forming optical element.

12. The imaging optical system according to claim 1, wherein:
the at least one optical aperture, the at least one beam-forming optical element and the at least one light-sensitive sensor can be arranged at vertices of a triangle, and/or
the at least one optical aperture and the at least one light-sensitive sensor can be arranged spatially between the at least one light source and the at least one beam-forming optical element.

13. A use of the imaging optical system according to claim 1 for detecting the position and/or movement of at least one object in space, wherein at least one light source is arranged on the at least one object.

14. A method for detecting the position and/or movement of at least one object in space, in particular using the imaging optical system according to claim 1, wherein:
light emitted by at least one object passes through at least one optical aperture, is reflected by at least one beam-forming optical element in the form of a planoconcave cylindrical mirror,
hits at least one light-sensitive sensor and is detected by it.

15. The method for detecting the position and/or movement of at least one object in space according to claim 14, wherein:
the light emitted by at least one object passes through the at least one optical aperture at a polar angle about a longitudinal direction of the optical aperture,
depending on the polar angle, hits a cylinder lateral segment of the planoconcave cylindrical mirror and is reflected,
depending on the polar angle, hits at a position along a longitudinal extension along a longitudinal direction of at least one light-sensitive sensor provided in the form of a line sensor or area sensor and is detected,
the polar angle can be determined by an evaluation device of an imaging optical system from the position of the impact along the longitudinal extension along a longitudinal direction of the at least one light-sensitive sensor.
